(19) United States
(12) Patent Application Publication
(10) Pub. No.: US 2021/0211426 A1
(43) Pub. Date: Jul. 8, 2021

(54) Accessing One or More Services via Local Terminals

(71) Applicant: CenturyLink Intellectual Property LLC, Broomfield, CO (US)

(72) Inventor: Justen Davis, Lone Tree, CO (US)

(21) Appl. No.: 16/882,883

(22) Filed: May 26, 2020

Related U.S. Application Data
(60) Provisional application No. 62/957,611, filed on Jan. 6, 2020.

(51) Int. Cl. H04L 29/06; H04L 29/08

(52) U.S. Cl. CPC H04L 63/10; H04L 67/16; H04L 67/10

(57) ABSTRACT

Novel tools and techniques are provided for implementing accessing of one or more services via a local terminal. The local terminal may receive a request for one or more services. The local terminal may determine whether it can provide access to the one or more services. Based on a determination that the local terminal cannot provide access to the one or more services, the local terminal might query a remote terminal to determine whether the remote terminal can provide access to, or one or more rules for accessing, the one or more services. Based on a determination that the remote terminal can provide the one or more rules for accessing the one or more services, the local terminal may receive the one or more rules from the remote terminal and access the one or more services based on the one or more rules.

### CROSS-REFERENCES TO RELATED APPLICATIONS

This application claims priority to U.S. Patent Application Ser. No. 62/957,611 (the “611 Application”), filed Jan. 6, 2020 by Justen Davis (attorney docket no. 1548-US-P1), entitled, “Accessing One or More Services via Local Terminals,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing accessing of one or more services via a local terminal, and, more particularly, to methods, systems, and apparatuses for implementing accessing of one or more services via a local terminal located on an external portion of a customer premises.

### BACKGROUND

Traditionally, incumbent local exchange carriers (“ILECs”) controlled the public switched telephone network (“PSTN”) infrastructure such as central offices (“COs”) and the last-mile copper fiber cable to customer premises. A competitive local exchange carrier (“CLEC”) would leverage the ILEC for connectivity and access to deliver local services such as voice services to customers. Much of the legacy equipment in the COs is at end of life and/or end of service life. This has led to increasing demand for space and power, network and infrastructure duplication, and increased costs to maintain the legacy equipment.

Hence, there is a need for more robust and scalable solutions for implementing accessing of one or more services via a local terminal, and, more particularly, to methods, systems, and apparatuses for implementing accessing of one or more services via a local terminal located on an external portion of a customer premises.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing accessing of one or more services via a local terminal, in accordance with various embodiments.

FIG. 2 is a schematic diagram illustrating another system for implementing accessing of one or more services via a local terminal, in accordance with various embodiments.

FIGS. 3A-3C are schematic diagrams illustrating yet another system for implementing accessing of one or more services via a local terminal, in accordance with various embodiments.

FIGS. 4A-4D are schematic diagrams illustrating still another system for implementing accessing of one or more services via a local terminal, in accordance with various embodiments.

FIGS. 5A-5C are flow diagrams illustrating a method for implementing accessing of one or more services via a local terminal, in accordance with various embodiments.

FIG. 6 is a block diagram illustrating an exemplary computer or system hardware architecture, in accordance with various embodiments.

FIG. 7 is a block diagram illustrating a networked system of computing systems, which may be used in accordance with various embodiments.

### DETAILED DESCRIPTION OF CERTAIN EMBODIMENTS

Overview

Various embodiments provide tools and techniques for implementing accessing of one or more services via a local terminal, and, more particularly, to methods, systems, and apparatuses for implementing accessing of one or more services via a local terminal located on an external portion of a customer premises.

In various embodiments, a local terminal located on an external portion of a customer premises might receive a request for one or more services. The request for one or more services might be received from a customer premises communicatively coupled to the local terminal. The local terminal might determine whether the local terminal can provide access to the one or more services. Based on a determination that the local terminal cannot provide access to the one or more services, the local terminal might query a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services. Based on a determination that the first remote terminal can provide the one or more rules for accessing the one or more services, the local terminal might receive, from the first remote terminal, the one or more rules for accessing the one or more services, and the local terminal might access the one or more services based on the one or more rules.

In some cases, the remote terminal might be a main terminal. The main terminal might include a database having a master list of the one or more rules for accessing the one or more services for a geographic region. For example, the main terminal might have a master list that has one or more rules for all customer premises within a particular geographic region. The geographic region might include, without limitation, at least one of a city, a region, a state, or a country, and/or the like.

The various embodiments provide advantages over the conventional public switched telephone network. The embodiments provide a centralized location (main terminal) where local terminals communicatively coupled to customer premises may obtain rules for accessing one or more services requested by users at a customer premises. The master list contained at a database of the main terminal might include, without limitation, at least one of information/rules associated with one or more customers within at least one of a city, a region, a state, or a country, information/rules associated with the one or more services that the one or more customers or one or more customer premises have permission to access, or information associated with one or more routes for accessing the one or more services, and/or the like.

The main terminal might use the request and/or information in the request as a search term to search the master list. The main terminal might search the master list to determine, without limitation, at least one of information/rules associated with one or more customers within at least one of a city, a region, a state, or a country, information/rules associated with the one or more services that the one or more customers or one or more customer premises have permission to access, or information associated with one or more routes for accessing the one or more services, and/or the like.

Further, by providing a centralized location to obtain information, the embodiments reduce the number of hops a request for services must take to access the one or more services. The embodiments also reduce the number of central offices needed to service a request from one or more local terminals because the master list is located at one centralized central office.

These and other features and advantages of the various embodiments are described in detail below with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, network technology, communication technology, central office technology, and/or the like. In other aspects, certain embodiments, can improve the functioning of user equipment or systems themselves (e.g., customer premises equipment, networking systems, communication systems, central office equipment, etc.), for example, based on a determination that the local terminal cannot provide access to the one or more services, querying, with the local terminal, a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and based on a determination that the first remote terminal can provide the one or more rules for accessing the one or more services, receiving, with the local terminal and from the first remote terminal, the one or more rules for accessing the one or more services, and accessing, with the local terminal, the one or more services based on the one or more rules; and/or the like. In particular, to the extent any abstract concepts are present in the various embodiments, those concepts can be implemented as described herein by devices, software, systems, and methods that involve specific novel functionality (e.g., steps or operations), such as, based on a determination that the local terminal cannot provide access to the one or more services, querying, with the local terminal, a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and based on a determination that the first remote terminal can provide the one or more rules for accessing the one or more services, receiving, with the local terminal and from the first remote terminal, the one or more rules for accessing the one or more services, and accessing, with the local terminal, the one or more services based on the one or more rules; and/or the like, to name a few examples, that extend beyond mere conventional computer processing operations. These functionalities can produce tangible results outside of the implementing computer system, including, merely by way of example, optimized and efficient routing of requests for services across one or more network terminals, optimized and efficient accessing of services across one or more network terminals, or the like.

In an aspect, a method might comprise receiving, with a local terminal located on an external portion of a customer premises, a request for one or more services; determining, with the local terminal, whether the local terminal can provide access to the one or more services; based on a determination that the local terminal cannot provide access to the one or more services, querying, with the local terminal, a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and based on a determination that the first remote terminal can provide the one or more rules for accessing the one or more services, receiving, with the local terminal and from the first remote terminal, the one or more rules for accessing the one or more services, and accessing, with the local terminal, the one or more services based on the one or more rules.

In some cases, the local terminal may be a distribution point unit located on the external portion of the customer premises. The distribution point unit may be attached to an exterior wall of the customer premises, located in a pedestal outside of the customer premises, or located below ground in a container located outside of the customer premises.

In some embodiments, the first remote terminal may be a central office located within at least one of a neighborhood or a city, and/or the like. The first remote terminal might be communicatively coupled to one or more local terminals within the neighborhood or city where the remote terminal is located. The first remote terminal might also be communicatively coupled to one or more local terminals located outside of the neighborhood or city where the remote terminal is located.

In some cases, the one or more services might include, without limitation, at least one of one or more voice services, one or more audio services, one or more video services, or one or more data services, and/or the like. In various instances, the one or more rules might include, without limitation, at least one of information associated with the one or more services that a user or a customer premises has permission to access or information associated with one or more routes for accessing the one or more services, and/or the like. The information associated with the one or more routes for accessing the one or more services might include, without limitation, at least one of one or more routes having a least amount of congestion or one or more routes having a least number of hops, and/or the like.

In various cases, the local terminal may be communicatively coupled to the first remote terminal and a second remote terminal. Based on a determination that the first remote terminal is experiencing at least one of congestion or an outage and based on the determination that the local terminal cannot provide access to the one or more services, the method might further include querying, with the local terminal, the second remote terminal communicatively coupled to the local terminal to determine at least one of whether the second remote terminal can provide access to the one or more services or whether the second remote terminal can provide one or more rules for accessing the one or more services.

In some embodiments, the method might further include based on a determination that the first remote terminal cannot provide access to the one or more services and cannot provide one or more rules for accessing the one or more services, querying, with the local terminal, a first main terminal, to determine at least one of whether the first main terminal can provide access to the one or more services or whether the first main terminal can provide the one or more rules for accessing the one or more services; and based on a determination that the first main terminal can provide the one or more rules for accessing the one or more services, receiving, with the local terminal and from the first main terminal, the one or more rules for accessing the one or more services, and accessing, with the local terminal, the one or more services based on the one or more rules.

In some instances, the main terminal might be communicatively coupled to one or more remote terminals and/or one or more local terminals. The main terminal may be a main central office located within at least one of a city, a region, a state, or a country, and/or the like. The main terminal might be communicatively coupled to one or more remote terminals and/or local terminals located within at least one of a city, a region, a state, or a country, and/or the like where the main terminal is located.

In some embodiments, the main terminal might include a database having a master list of the one or more rules for accessing the one or more services. The master list might include, without limitation, at least one of information associated with one or more customers or one or more customer premises within at least one of a city, a region, a state, or a country, information associated with the one or more services that the one or more customers or one or more customer premises have permission to access within at least one of a city, a region, a state, or a country, or information associated with one or more routes for accessing the one or more services.

In various embodiments, the method might further include based on a determination that the first main terminal cannot provide access to the one or more services and cannot provide one or more rules for accessing the one or more services, querying, with the local terminal via the first main terminal, a second main terminal, to determine at least one of whether the second main terminal can provide access to the one or more services or whether the second main terminal can provide the one or more rules for accessing the one or more services, wherein the second main terminal is communicatively coupled to the first main terminal; and based on a determination that the second main terminal can provide the one or more rules for accessing the one or more services, receiving, with the local terminal and from the second main terminal via the first main terminal, the one or more rules for accessing the one or more services, and accessing, with the local terminal, the one or more services based on the one or more rules.

In various cases, the second main terminal might provide a backup of the one or more rules of the first main terminal. When the first main terminal is experiencing congestion or an outage, the first main terminal might automatically pass the query from the local terminal to the second main terminal without processing the query. The first main terminal and the second main terminal may be located in at least one of different cities, different regions, different states, or different countries and the first main terminal and the second main terminal may be communicatively coupled together via low-latency transport lines.

The method might further include based on a determination that the first remote terminal is experiencing at least one of congestion or an outage, querying, with the local terminal, a first main terminal, to determine at least one of whether the first main terminal can provide access to the one or more services or whether the first main terminal can provide the one or more rules for accessing the one or more services; and based on a determination that the first main terminal can provide the one or more rules for accessing the one or more services, receiving, with the local terminal and from the first main terminal, the one or more rules for accessing the one or more services, and accessing, with the local terminal, the one or more services based on the one or more rules. In some instances, the first remote terminal might automatically pass the query from the local terminal to the first main terminal without processing the query.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a request for one or more services; determine whether the apparatus can provide access to the one or more services, wherein the apparatus is located on an external portion of a customer premises; based on a determination that the apparatus cannot provide access to the one or more services, query a first remote terminal among one or more remote terminals that are located remote from the apparatus and communicatively coupled to the apparatus to determine at least one of whether the first remote terminal can provide access to the one or more services or whether the first remote terminal can provide one or more rules for accessing the one or more services; and based on a determination that the first remote terminal can provide the one or more rules for accessing the one or more services, receive, from the first remote terminal, the one or more rules for accessing the one or more services, and access the one or more services based on the one or more rules.

In yet another aspect, a system might comprise a local terminal located on an external portion of a customer premises. The local terminal might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the local terminal to: receive a request for one or more services; determine whether the local terminal can provide access to the one or more services; based on a determination that the local terminal cannot provide access to the one or more services, query a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and based on a determination that the first remote terminal can provide the one or more rules for accessing the one or more services, receive, from the first remote terminal, the one or more rules for accessing the one or more services, and access the one or more services based on the one or more rules.

The system might further include the first remote terminal. The first remote terminal might comprise at least one second processor and a second non-transitory computer readable medium communicatively coupled to the at least one second processor. The second non-transitory computer readable medium having stored thereon computer software comprising a second set of instructions that, when executed by the at least one second processor, causes the first remote terminal to: receive the query for the one or more services from the local terminal; determine at least one of whether the first remote terminal can provide access to the one or more services or whether the first remote terminal can provide one or more rules for accessing the one or more services; and based on a determination that the first remote terminal can provide the one or more rules for accessing the one or more services, send the one or more rules to the local terminal for accessing the one or more services.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

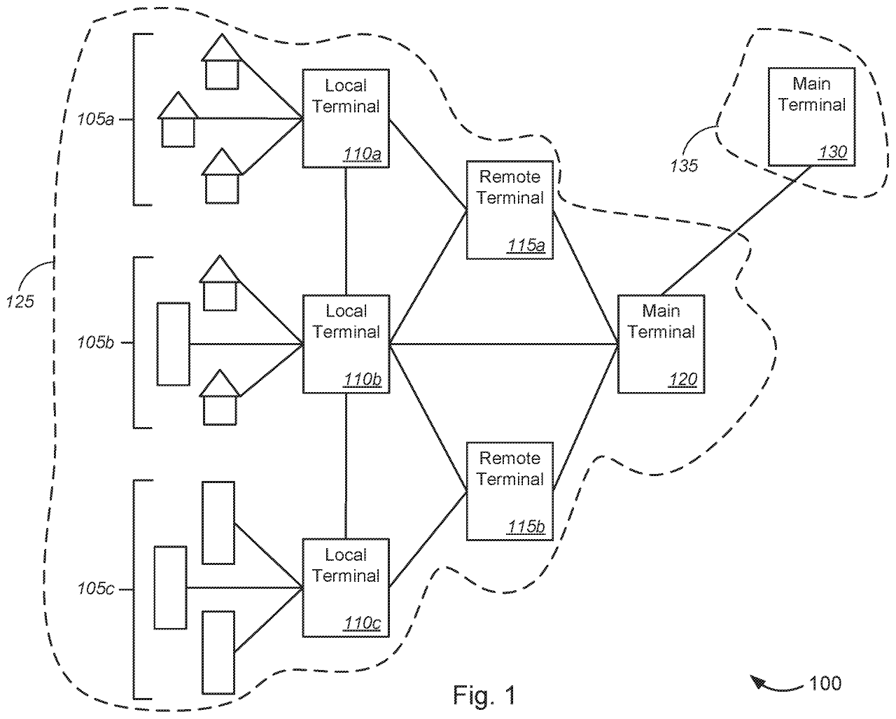

We now turn to the embodiments as illustrated by the drawings. FIGS. 1-7 illustrate some of the features of the method, system, and apparatus for implementing accessing of one or more services via a local terminal, and, more particularly, to methods, systems, and apparatuses for implementing accessing of one or more services via a local terminal located on an external portion of a customer premises, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

With reference to the figures, FIG. 1 is a schematic diagram illustrating a system 100 for implementing accessing of one or more services via a local terminal, in accordance with various embodiments.

In the non-limiting embodiment of FIG. 1, system 100 might comprise one or more customer premises 105a-105c (collectively, “customer premises 105” or the like). Customer premises 105 might include, without limitation, a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, or an industrial building or complex, and/or the like. Customer premises 105 might be located in at least one of a residential neighborhood, in a location with mixed residential and commercial buildings, or in a location with only commercial buildings, and/or the like.

In various embodiments, customer premises 105 might be communicatively coupled via a wired and/or wireless connection to one or more local terminal(s) 110a-110c (collectively, “local terminals 110” or the like). One local terminal 110 may correspond to each customer premises. Alternatively, one local terminal 110 may correspond to multiple customer premises 105. In other embodiments, one customer premises may be connected to multiple local terminals 110.

The local terminal 110 may be a distribution point unit located on an external portion of the customer premises 105. The distribution point unit may be located in a pedestal outside of the customer premises 105, below ground in a container outside of the customer premises 105, or mounted to an exterior wall of the customer premises 105, and/or the like. The local terminals 110 might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application-specific integrated circuits (“ASIC”), or a system on a chip (“SoC”), and/or the like.

Customer premises 105 may access or request access to one or more services via local terminals 110. The one or more services might include, without limitation, at least one of one or more voice services, one or more audio services, one or more video services, or one or more data services, and/or the like.

In some cases, local terminal(s) 110 may be communicatively coupled via a wired and/or wireless connection to one or more remote terminal(s) 115a and 115b (collectively, “remote terminals 115” or the like). The remote terminals 115 may be coupled to multiple local terminals 110. In a non-limiting example, remote terminal 115a is communicatively coupled to local terminal 110a and 110b. Additionally and/or alternatively, remote terminal 115a may be communicatively coupled to other remote terminals, such as remote terminal 115b.

The remote terminals 115 are remote from the local terminals 110. In a non-limiting example, the remote terminals 115 may be one or more central offices located within at least one of a neighborhood or a city, and/or the like. The one or more central offices might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application-specific integrated circuits (“ASIC”), or a system on a chip (“SoC”), and/or the like.

Local terminals 110 may access or request access to one or more services via remote terminals 115.

In some instances, local terminals 110 and/or remote terminals 115 may be communicatively coupled via a wired and/or wireless connection to a main terminal 120. In some cases, local terminals 110 may be directly coupled to main terminal 120, as shown by the connection between local terminal 110b and the main terminal 120. In other cases, local terminals 110 may be connected to a main terminal 120 via remote terminals 115. This is illustrated by local terminal 110a being connected to main terminal 120 via remote terminal 115a and local terminal 110c being connected to main terminal 120 via remote terminal 115b.

The main terminal 120 may be a main central office located within at least one of a city, a region, a state, or a country. The main central office might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application-specific integrated circuits (“ASIC”), or a system on a chip (“SoC”), and/or the like.

The main terminal 120 may include a database having a master list of one or more rules for accessing one or more services for one or more customer premises 105 within a geographic region 125. The geographic region 125 might include, without limitation, at least one of a city, a region, a state, or a country. The master list may include, without limitation, at least one of: information and/or rules associated with one or more customers or one or more customer premises located within at least one of a city, a region, a state, or a country; information and/or rules associated with the one or more services that the one or more customers or the one or more customer premises have permission to access; or information and/or rules associated with one or more routes for accessing the one or more services; and/or the like.

The main terminal 120 may be communicatively coupled via a wired and/or wireless connection to one or more other main terminals 130. The main terminal 120 and the main terminal 130 may be communicatively coupled together via low-latency transport lines. The other main terminal 130 may include a database having a master list of one or more rules for accessing one or more services for another geographic region 135. The geographic region 135 might include, without limitation, at least one of a city, a region, a state, or a country. Geographic region 135 may be separate and different from geographic region 125.

In some embodiments, the main terminal 130 may back up the main terminal 120. In other words, the main terminal 130 may have a duplicate copy of the master list of main terminal 120. Additionally and/or alternatively, the main terminal 120 may back up the main terminal 130. In other words, the main terminal 120 may have a duplicate copy of the master list of main terminal 130.

In operation, a local terminal 110b may receive a request for one or more services from a user at customer premises 105b. The one or more services may include, without limitation, one or more voice services, one or more audio services, one or more video services, or one or more data services, and/or the like.

The local terminal 110b may determine whether the local terminal 110b can provide access to the one or more services requested by the user at the customer premises 105b. Based on a determination that the local terminal 110b can provide access to the one or more services, the local terminal 110b might provide access to the one or more services requested by the user.

In some embodiments, based on a determination that the local terminal 110b cannot provide access to the one or more services, the local terminal 110b might query a first remote terminal 115a that is located remote from the local terminal 110b to determine at least one of whether the first remote terminal 115a can provide access to the one or more services or whether the first remote terminal 115a can provide one or more rules for accessing the one or more services. Based on a determination that the first remote terminal 115a can provide access to the one or more services, the first remote terminal 115a may provide the customer at the customer premises 105b with access to the one or more services. Based on a determination that the first remote terminal 115a can provide the one or more rules for accessing the one or more services, the local terminal 110b may receive the one or more rules from the first remote terminal 115a and may access the one or more services based on the one or more rules.

Based on a determination that the first remote terminal 115a cannot provide access to the one or more services and cannot provide one or more rules for accessing the one or more services, the local terminal 110b might query a first main terminal 120 to determine at least one of whether the first main terminal 120 can provide access to the one or more services or whether the first main terminal 120 can provide the one or more rules for accessing the one or more services. Based on a determination that the first main terminal 120 can provide access to the one or more services, the first main terminal 120 may provide the customer at the customer premises 105b with access to the one or more services. Based on a determination that the first main terminal 120 can provide the one or more rules for accessing the one or more services, the local terminal 110b may receive from the first main terminal 120 the one or more rules for accessing the one or more services and may access the one or more services based on the one or more rules.

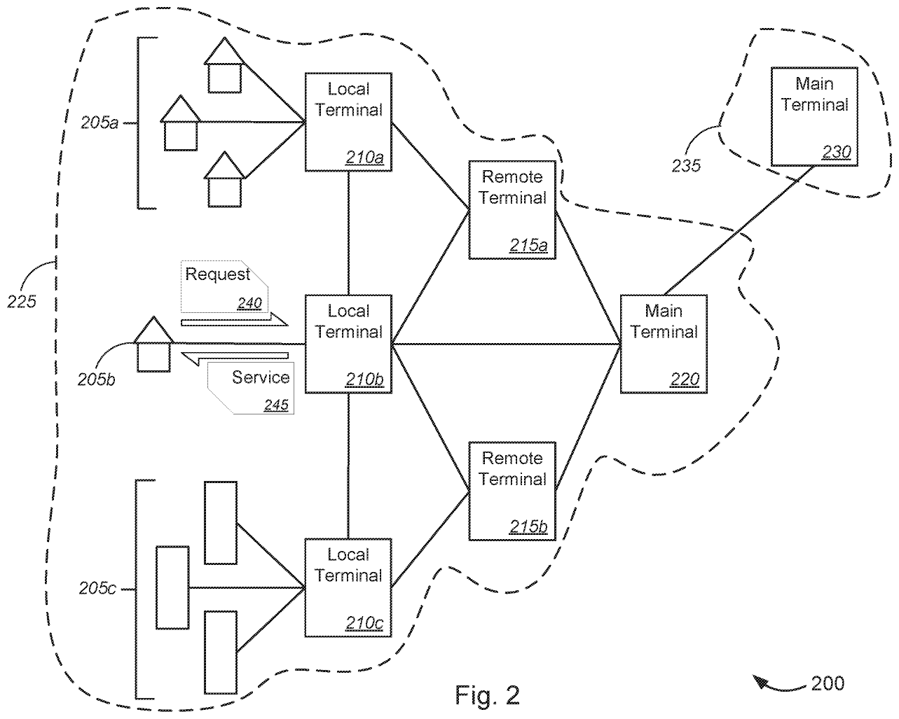

The operation of system 100 is further described below with respect to FIGS. 2-4.

FIG. 2 is a schematic diagram illustrating a system 200 for implementing accessing of one or more services via a local terminal, in accordance with various embodiments. System 200 represents a portion of the system 100 of FIG. 1, and may operate in a similar manner as system 100 of FIG. 1.

System 200 might comprise one or more customer premises 205a-205c (which may correspond to customer premises 105a-105c of FIG. 1), one or more local terminals 210a-210c (which may correspond to local terminals 110a-110c of FIG. 1), one or more remote terminals 215a and 215b (which may correspond to remote terminals 115a and 115b of FIG. 1), a first main terminal 220 and a second main terminal 230 (which may correspond to a first main terminal 120 and a second main terminal 130 of FIG. 1), and a first geographic region 225 and a second geographic region 235 (which may correspond to first geographic region 125 and second geographic region 135 of FIG. 1), and/or the like.

In operation, a local terminal 210b may receive a request 240 for one or more services from a user device at customer premises 205b. The one or more services may include, without limitation, one or more voice services, one or more audio services, one or more video services, or one or more data services, and/or the like.

The local terminal 210 may determine whether the local terminal 210b can provide access to the one or more services requested by the user at the customer premises 205b. In some cases, the local terminal 210b might also determine whether a user and/or a customer premises 205b has been authorized to access the one or more requested services. The authorization may be based on a determination whether a user has subscribed to and/or paid for the one or more services, and/or the like.

Based on a determination that the local terminal 210b can provide access to the one or more services and/or based on a determination that the user and/or customer premises has been authorized to access the one or more services, the local terminal 210b might provide access to the service 245 requested by the user device at the customer premises 205b.

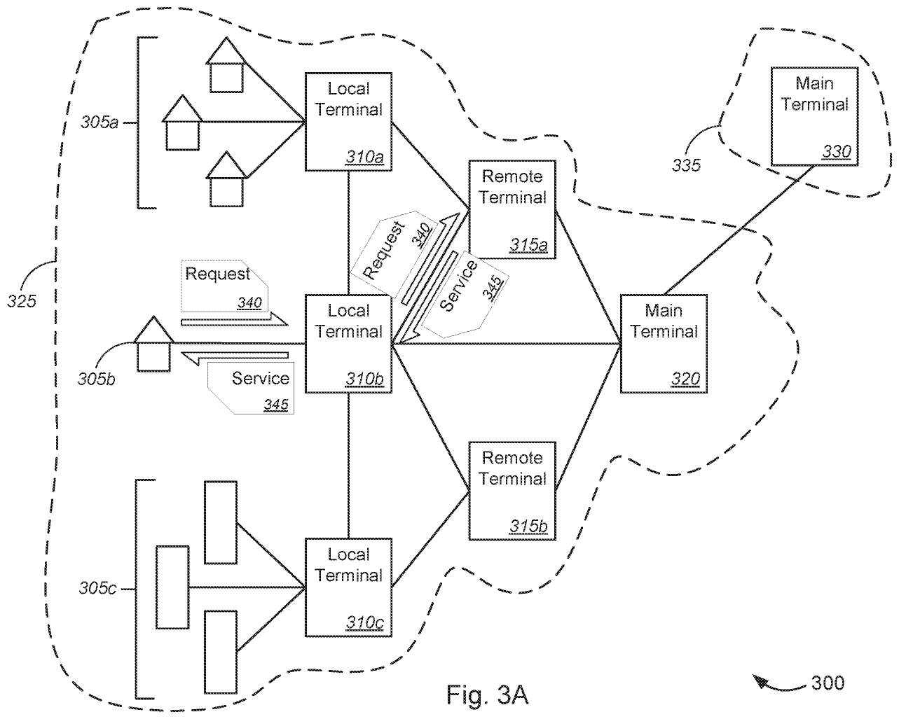

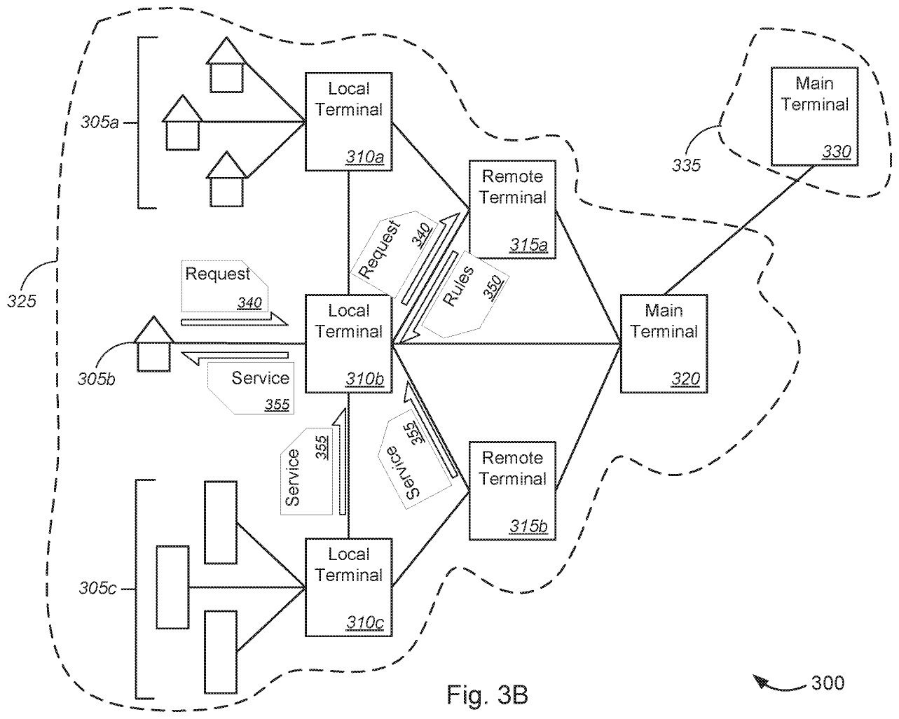

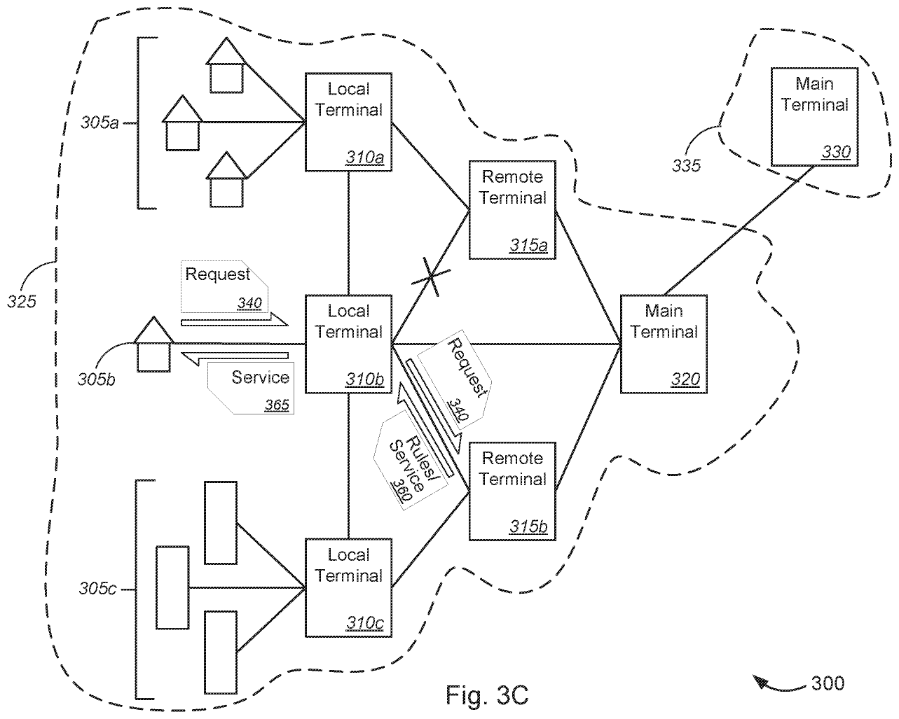

FIGS. 3A-3C (collectively, FIG. 3) are schematic diagrams illustrating a system 300 for implementing accessing of one or more services via a local terminal, in accordance with various embodiments. System 300 represents a portion of the system 100 of FIG. 1, and may operate in a similar manner as system 100 of FIG. 1.

System 300 might comprise one or more customer premises 305a-305c (which may correspond to customer premises 105a-105c and 205a-205c of FIGS. 1 and 2, respectively), one or more local terminals 310a-310c (which may correspond to local terminals 110a-110c and 210a-210c of FIGS. 1 and 2, respectively), one or more remote terminals 315a and 315b (which may correspond to remote terminals 115a, 115b, 215a, and 215b of FIGS. 1 and 2, respectively), a first main terminal 320 and a second main terminal 330 (which may correspond to first main terminal 120 and second main terminal 130 of FIG. 1 and first main terminal 220 and second main terminal 230 of FIG. 2), and a first geographic region 325 and a second geographic region 335 (which may correspond to first geographic region 125 and second geographic region 135 of FIG. 1 and first geographic region 225 and second geographic region 235 of FIG. 2), and/or the like.

In operation, a local terminal 310b may receive a request 340 for one or more services from a user device at customer premises 305b. The one or more services may include, without limitation, one or more voice services, one or more audio services, one or more video services, or one or more data services, and/or the like.

In some cases, the local terminal 310b may determine whether the local terminal 310b can provide access to the one or more services requested by the user at the customer premises 305b. Based on a determination that the local terminal 310b cannot provide access to the one or more services, the local terminal 310b might query a first remote terminal 315a among one or more remote terminals that are located remote from the local terminal 310a and communicatively coupled to the local terminal 310b to determine at least one of whether the first remote terminal 315a can provide access to the one or more services or whether the first remote terminal 315a can provide one or more rules for accessing the one or more services.

In other cases, the local terminal 310b might automatically pass or forward the request 340 to the first remote terminal 315a without processing the request 340. In other words, the local terminal 310b might not determine whether the local terminal 310b can access the one or more services and, instead, automatically forward the request 340 to the first remote terminal 315a.

When the first remote terminal 315a receives the request 340, the first remote terminal 315a might process the request 340 to determine whether the first remote terminal 315a can provide access to the one or more services or whether the first remote terminal 315a can provide one or more rules for accessing the one or more services. The first remote terminal 315a might also determine whether a user and/or a customer premises 305b has been authorized to access the one or more requested services. The authorization may be based on a determination whether a user has subscribed to and/or paid for the one or more services, and/or the like.

Based on a determination that the first remote terminal 315a can provide access to the one or more services and/or based on a determination that the user and/or customer premises 305b is authorized to receive the one or more services, the first remote terminal 315a might provide the one or more services 345 to the customer premises 305b via the local terminal 310b, as shown in FIG. 3A.

Based on a determination that the first remote terminal 315a can provide one or more rules 350 for accessing the one or more services and/or based on a determination that the user and/or customer premises 305b is authorized to receive the one or more services, the first remote terminal 315a might provide the one or more rules 350 to the local terminal 310b, as shown in FIG. 3B.

The one or more rules 350 might include, without limitation, information associated with the one or more services that a user or a customer premises has permission to access or information associated with one or more routes for accessing the one or more services, and/or the like. The information associated with the one or more routes for accessing the one or more services might include, without limitation, at least one of one or more routes having a least amount of congestion or one or more routes having a least number of hops, and/or the like.

The local terminal 310b might then use the one or more rules provided by the first remote terminal 315a to access the one or more services. The local terminal 310b might access the one or more services via the one or more routes indicated by the one or more rules 350. In a non-limiting example, the one or more rules 350 might indicate that second remote terminal 315b might be able to provide the one or more services 355 and/or that local terminal 310c might be able to provide the one or more services 355. Local terminal 310b might then access the one or more services 355 from the second remote terminal 315b and/or from local terminal 310c based on the one or more routes provided by the first remote terminal 315a.

Additionally and/or alternatively, local terminal 310b might be communicatively coupled to a first remote terminal 315a and a second remote terminal 310b. First remote terminal 315a might be designated as the primary remote terminal that receives requests for services from local terminal 310b. However, sometimes local terminal 310b might not be able to query first remote terminal 315a. Based on a determination that the first remote terminal 315a is experiencing at least one of congestion or an outage, the local terminal 310b might instead query the second remote terminal 315b communicatively coupled to the local terminal 310b to determine at least one of whether the second remote terminal 315b can provide access to the one or more services 360 or whether the second remote terminal can provide one or more rules for accessing the one or more services 360, as shown by FIG. 3C.

Based on a determination that the second remote terminal 315b can provide access to the one or more services 360 and/or one or more rules 360 for accessing the one or more services 360, the second remote terminal 315b might provide the one or more rules/services 360 to the local terminal 310b. The local terminal 310b might then (1) provide the one or more services 365 to the customer premises 305b or (2) access and provide the one or more services 365 based on the or more rules received from the second remote terminal 315b.

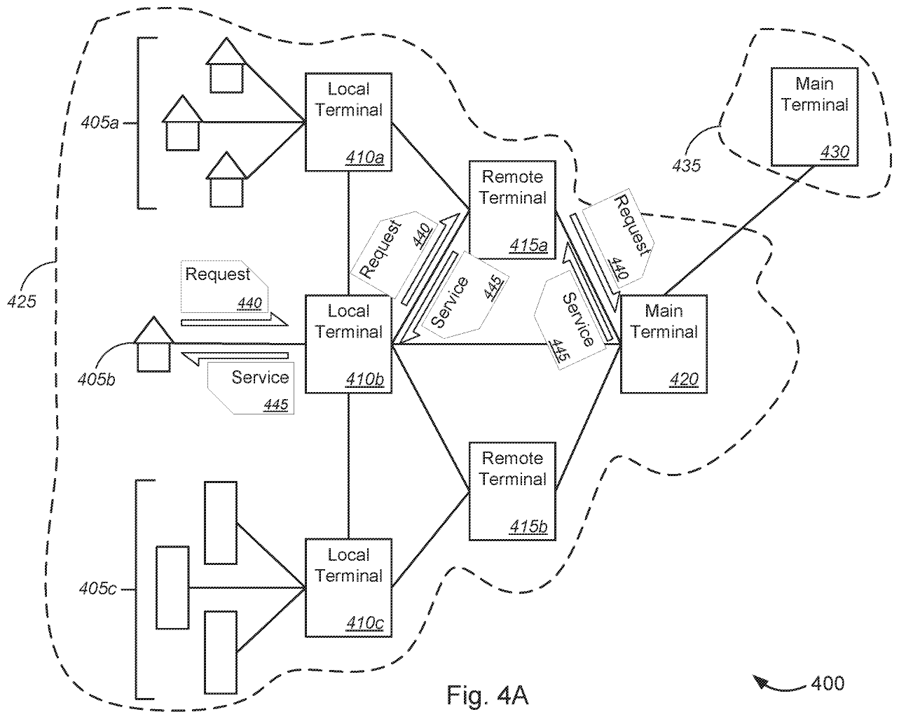

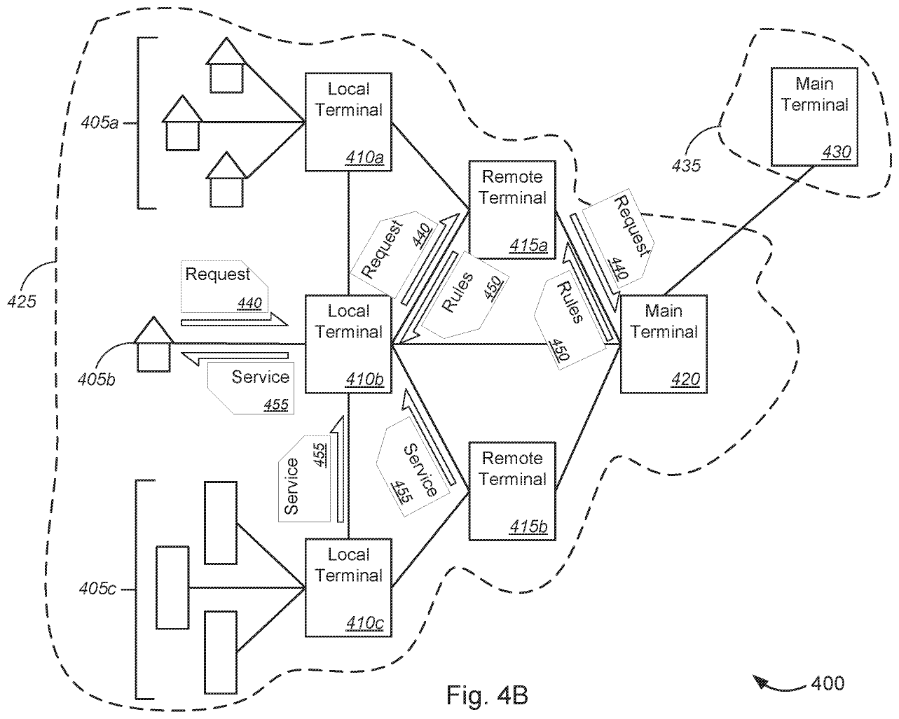

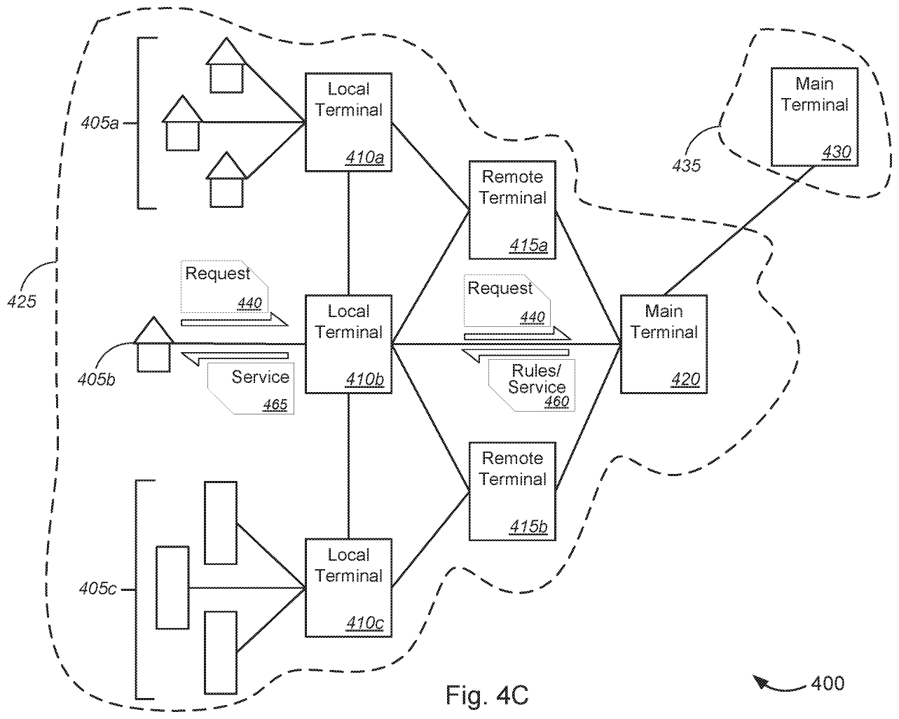

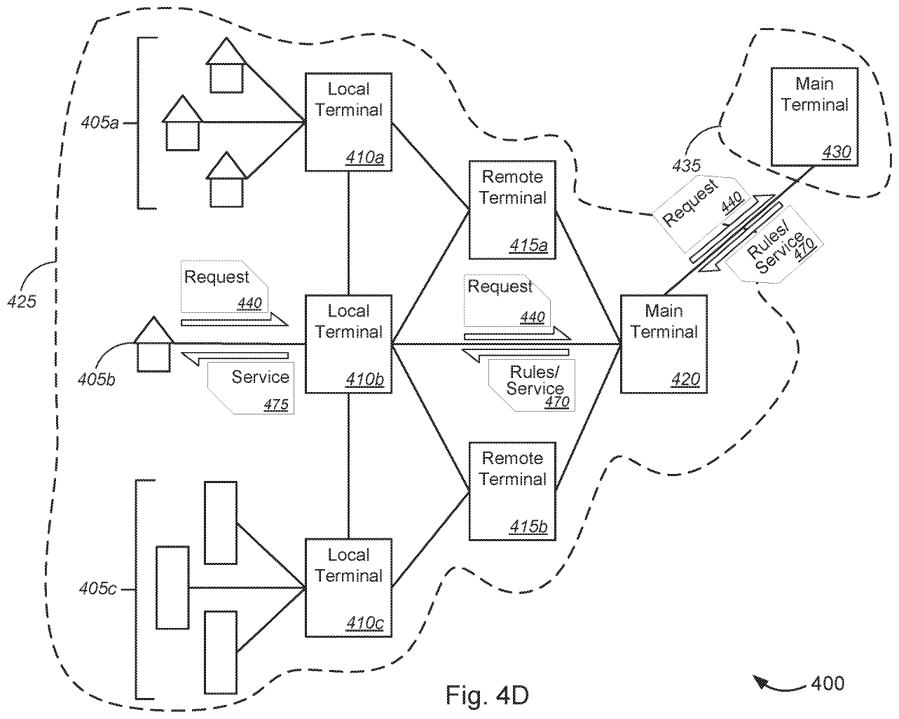

FIGS. 4A-4D (collectively, FIG. 4) are schematic diagrams illustrating a system 400 for implementing accessing of one or more services via a local terminal, in accordance with various embodiments. System 400 represents a portion of the system 100 of FIG. 1, and may operate in a similar manner as system 100 of FIG. 1.

System 400 might comprise one or more customer premises 405a-405c (which may correspond to customer premises 105a-105c, 205a-205c, and 305a-305c of FIGS. 1, 2, and 3, respectively), one or more local terminals 410a-410c (which may correspond to local terminals 110a-110c, 210a-210c, and 310a-310c of FIGS. 1, 2, and 3, respectively), one or more remote terminals 415a and 415b (which may correspond to remote terminals 115a, 115b, 215a, 215b, and 315a, and 315b of FIGS. 1, 2, and 3, respectively), a first main terminal 420 and a second main terminal 430 (which may correspond to first main terminal 120 and second main terminal 130 of FIG. 1, first main terminal 220 and second main terminal 230 of FIG. 2, and first main terminal 320 and second main terminal 330 of FIG. 3), and a first geographic region 425 and a second geographic region 435 (which may correspond to first geographic region 125 and second geographic region 135 of FIG. 1, first geographic region 225 and second geographic region 235 of FIG. 2, first geographic region 325 and second geographic region 335 of FIG. 3), and/or the like.

In operation, a local terminal 410b may receive a request 440 for one or more services from a user device at customer premises 405b. The one or more services may include, without limitation, one or more voice services, one or more audio services, one or more video services, or one or more data services, and/or the like.

In some cases, the local terminal 410b may determine whether the local terminal 410b can provide access to the one or more services requested by the user device at the customer premises 405b. Based on a determination that the local terminal 410b cannot provide access to the one or more services, the local terminal 410b might query a first remote terminal 415a among one or more remote terminals that are located remote from the local terminal 410b and communicatively coupled to the local terminal 410b to determine at least one of whether the first remote terminal 415a can provide access to the one or more services or whether the first remote terminal 415a can provide one or more rules for accessing the one or more services.

In other cases, the local terminal 410b might automatically pass or forward the request 440 to the first remote terminal 415a without processing the request 440. In other words, the local terminal 410b might not determine whether the local terminal 410b can access the one or more services and automatically forward the request to the first remote terminal 415a.

When the first remote terminal 415a receives the request 440, the first remote terminal 415a might process the request to determine whether the first remote terminal 415a can provide access to the one or more services or whether the first remote terminal 415a can provide one or more rules for accessing the one or more services. Based on a determination that the first remote terminal 415a cannot provide access to the one or more services, the first remote terminal 415a might query a first main terminal 420 that is communicatively coupled to the first remote terminal 415a to determine at least one of whether the first main terminal 420 can provide access to the one or more services or whether the first main terminal 420 can provide one or more rules for accessing the one or more services.

In other cases, the first remote terminal 410a might automatically pass or forward the request 440 to a first main terminal 420 without processing the request 440. In other words, the first remote terminal 415a might not determine whether the first remote terminal 415a can access the one or more services and automatically forward the request to the first main terminal 420. The passing of the request 440 may occur automatically and/or based on a determination that the first remote terminal 415a is experiencing at least one of congestion or an outage.

When the first main terminal 420 receives the request 440, the first main terminal 420 might process the request to determine whether the first main terminal 420 can provide access to the one or more services or whether the first main terminal 420 can provide one or more rules for accessing the one or more services. The first main terminal 420 might also determine whether a user and/or a customer premises 405b has been authorized to access the one or more requested services. The authorization may be based on a determination regarding whether a user has subscribed to and/or paid for the one or more services, and/or the like.

Based on a determination that the first main terminal 420 can provide access to the one or more services and/or based on a determination that the user and/or customer premises 405b is authorized to receive the one or more services, the first main terminal 420 might provide the one or more services 445 to the customer premises 405b via the local terminal 410b and/or remote terminal 415a, as shown in FIG. 4A. Although not shown, if a connection exists directly between the first main terminal 420 and the local terminal 410b, the first main 420 might provide the one or more services 445 to the customer premises 405b via such a direct connection and via the local terminal 410b.

Based on a determination that the first main terminal 420 can provide one or more rules 450 for accessing the one or more services and/or based on a determination that the user and/or customer premises 405b is authorized to receive the one or more services, the first main terminal 420 might provide the one or more rules 450 to the local terminal 410b, via the first remote terminal 415a, as shown in FIG. 4B.

The one or more rules 450 might include, without limitation, information associated with the one or more services that a user or a customer premises has permission to access or information associated with one or more routes for accessing the one or more services, and/or the like. The information associated with the one or more routes for accessing the one or more services might include, without limitation, at least one of one or more routes having a least amount of congestion or one or more routes having a least number of hops, and/or the like.

The local terminal 410b might then use the one or more rules provided by the first main terminal 420 to access the one or more services. The local terminal 410b might access the one or more services via the one or more routes indicated by the one or more rules. For example, the one or more rules might indicate that remote terminal 415b might be able to provide the one or more services 455 and/or that local terminal 410c might be able to provide the one or more services 455. Local terminal 410b might then access the one or more services 455 from remote terminal 415b and/or local terminal 410c based on the one or more routes provided by the first main terminal 420.

In some cases, as shown by FIG. 4C, the local terminal 410b might be directly coupled to first main terminal 420, without any intermediate remote terminals 415. In this case, a local terminal 410b may receive a request 440 for one or more services from a user device at customer premises 405b. The one or more services may include, without limitation, one or more voice services, one or more audio services, one or more video services, or one or more data services, and/or the like.

In some cases, the local terminal 410b may determine whether the local terminal 410b can provide access to the one or more services requested by the user at the customer premises 405b. Based on a determination that the local terminal 410b cannot provide access to the one or more services, the local terminal 410b might query a first main terminal 420 to determine at least one of whether the first main terminal 420 can provide access to the one or more services or whether the first main terminal 420 can provide one or more rules for accessing the one or more services.

In other cases, the local terminal 410b might automatically pass or forward the request 440 to a first main terminal 420 without processing the request 440. In other words, the local terminal 410b might not determine whether the local terminal 410b can access the one or more services and automatically forward the request to first main terminal 420.

When the first main terminal 420 receives the request 440, the first main terminal 420 might process the request to determine whether the first main terminal 420 can provide access to the one or more services or whether the first main terminal 420 can provide one or more rules for accessing the one or more services.

Based on a determination that the first main terminal 420 can provide access to the one or more services and/or based on a determination that the user and/or customer premises 405b is authorized to receive the one or more services, the first main terminal 420 might provide the one or more services 465 to the customer premises 405b via the local terminal 410b.

Based on a determination that the first main terminal 420 can provide one or more rules 460 for accessing the one or more services and/or based on a determination that the user and/or customer premises 405b is authorized to receive the one or more services 465, the first main terminal 420 might provide the one or more rules 460 to the local terminal 410b.

Additionally and/or alternatively, based on a determination that the first main terminal 420 is experiencing at least one of congestion or an outage, the local terminal 410b might instead query, via the first main terminal 420, a second main terminal 430, to determine at least one of whether the second main terminal 430 can provide access to the one or more services or whether the second main terminal 430 can provide the one or more rules for accessing the one or more services. The second main terminal 430 may be communicatively coupled to the first main terminal 420 via one or more low-latency transport lines. In some cases, when the first main terminal 420 is experiencing at least one of congestion or an outage, the first main terminal 420 might automatically pass the request 440 to the second main terminal 430, without processing the request 440.

Based on a determination that the second main terminal 430 can provide access to the one or more services and/or one or more rules for accessing the one or more services, the second main terminal 430 might provide the one or more services 475 to the customer premises 405b via the local terminal 410b. Alternatively, based on a determination that the second main terminal 430 can provide one or more rules 470 for accessing the one or more services 475, the second main terminal 430 might provide the one or more rules 470 to the local terminal 410b, as shown in FIG. 4D. The local terminal 410b might then use the one or more rules provided by the second main terminal 430 to access the one or more services and provide the one or more services 475 to customer premises 405b.

In FIGS. 4A-4D, the first main terminal 420 may include a database having a master list of one or more rules for accessing one or more services for one or more customer premises 405 within a geographic region 425. The database may be contained within one computing system and/or distributed throughout multiple computing systems.

The first main terminal 420 may act as the primary or centralized resource for accessing one or more services for one or more customer premises 405, local terminals 410, and remote terminals 415 within a geographic region 425. The geographic region 425 might include, without limitation, at least one of a city, a region, a state, or a country. The master list may include, without limitation, at least one of information and/or rules associated with one or more customers or one or more customer premises within at least one of a city, a region, a state, or a country, information/rules associated with the one or more services that the one or more customers or the one or more customer premises have permission to access, or information and/or rules associated with one or more routes for accessing the one or more services, and/or the like.

In various cases, when the first main terminal 420 receives the request 440 for one or more services, the first main terminal 420 may use, without limitation, the request 440 and/or information contained within the request as a search term to search the database containing the master list. The information included within the request may include, without limitation, at least one of a source associated with the request, a user associated with the request, a user device associated with the request, a customer premises associated with the request, a virtual local area network associated with the request, an internet protocol address associated with the request, a uniform resource identifier associated with the request, or a uniform resource locator associated with the request, and/or the like. The master list may be organized based on at least one of one or more services, a source, a user, a customer premises, a virtual local area network, an internet protocol address, a uniform resource identifier, or a uniform resource locator, and/or the like.

In some instances, when a user at customer premises 405b activates or subscribes to a new service, the master list located at the first main terminal 420 may be automatically updated. The local terminal 410b might send a notification via the remote terminal 415b and/or directly to the first main terminal 420 indicating that the master list needs to be updated with the new service subscription. The master list may be updated to indicate that a user, user device, and/or customer premises is authorized to access the new service, where to access the new service, one or more paths to access the new service, and/or the like.

The first main terminal 420 may be communicatively coupled via a wired and/or wireless connection to one or more second main terminals 430. The first main terminal 420 and the second main terminal 430 may be communicatively coupled together via low-latency transport lines. The second main terminal 430 may include a database having a master list of one or more rules for accessing one or more services for another geographic region 435. The geographic region 435 might include, without limitation, at least one of a city, a region, a state, or a country. Geographic region 435 may be separate and different from geographic region 425.

In some embodiments, the second main terminal 430 may back up the first main terminal 420. In other words, the second main terminal 430 may have a duplicate copy of the master list of the first main terminal 420. Additionally and/or alternatively, the first main terminal 420 may back up the second main terminal 430. In other words, the first main terminal 420 may have a duplicate copy of the master list of the second main terminal 430. When the first main terminal is experiencing congestion or an outage, the first main terminal 420 might automatically pass the query from the local terminal 410b to the second main terminal 430 without processing the query. The master list of the first main terminal 420 may be backed up to the second main terminal 430 periodically (e.g., hourly, daily, weekly, monthly, etc.) and/or when the master list located at the first main terminal 420 is updated with one or more new services.

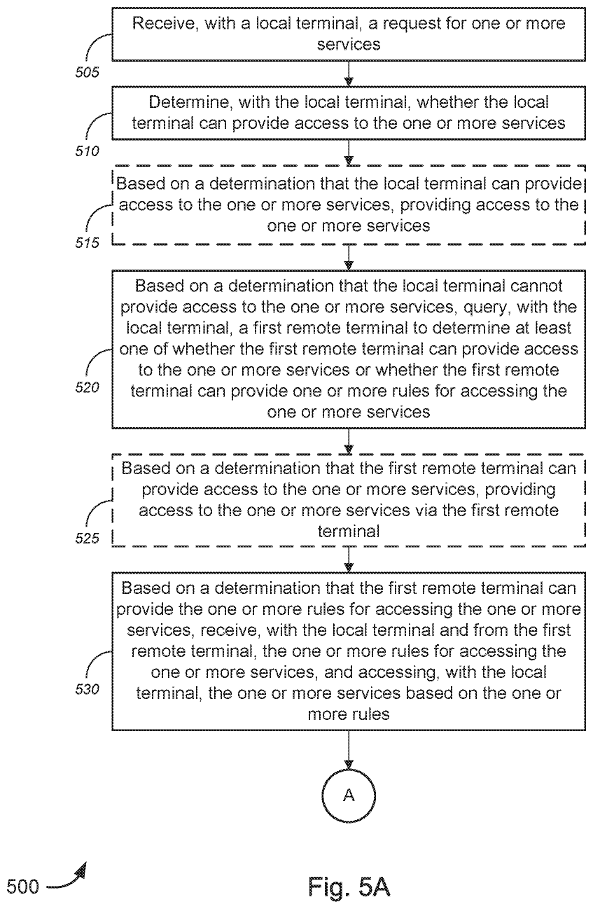

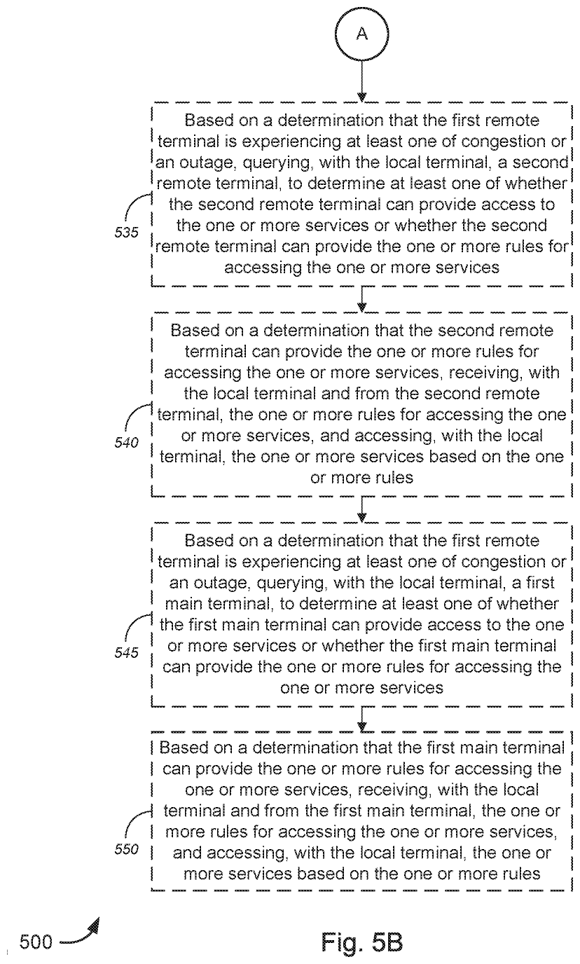

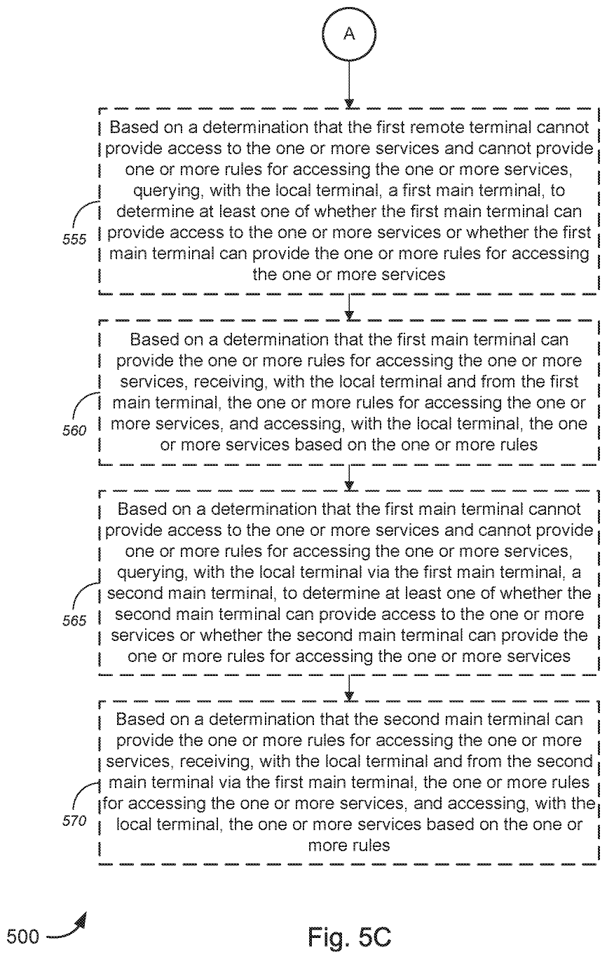

FIGS. 5A-5C (collectively, “FIG. 5”) are flow diagrams illustrating a method for implementing accessing of one or more services via a local terminal, in accordance with various embodiments. Method 500 of FIG. 5A continues onto FIG. 5B following the circular marker denoted, “A.”

While the techniques and procedures are depicted and/or described in a certain order for purposes of illustration, it should be appreciated that certain procedures may be reordered and/or omitted within the scope of various embodiments. Moreover, while the method 500 illustrated by FIG. 5 can be implemented by or with (and, in some cases, are described below with respect to) the systems, examples, or embodiments 100, 200, 300, and 400 of FIGS. 1, 2, 3, and 4, respectively (or components thereof), such methods may also be implemented using any suitable hardware (or software) implementation. Similarly, while each of the systems, examples, or embodiments 100, 200, 300, and 400 of FIGS. 1, 2, 3, and 4, respectively, (or components thereof), can operate according to the method 500 illustrated by FIG. 5 (e.g., by executing instructions embodied on a computer readable medium), the systems, examples, or embodiments 100, 200, 300, and 400 of FIGS. 1, 2, 3, and 4 can each also operate according to other modes of operation and/or perform other suitable procedures.

In the non-limiting embodiment of FIG. 5A, method 500, at block 505, might comprise receiving, with a local terminal located on an external portion of a customer premises, a request for one or more services. The local terminal might be a distribution point unit located on the external portion of the customer premises. The local terminal might be communicatively coupled to the customer premises. Alternatively, the local terminal might be communicatively coupled to one or more user devices located at the customer premises.

The local terminals might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application specific integrated circuits (“ASIC”), or a system on a chip (“SoC”), and/or the like.

The request for one or more services may be sent to the local terminal by a user on a user device at the customer premises. The one or more services might include, without limitation, at least one of one or more voice services, one or more audio services, one or more video services, or one or more data services, and/or the like.

At block 510, method 500 might include determining, with the local terminal, whether the local terminal can provide access to the one or more services. Based on a determination that the local terminal can provide access to the one or more services, the method 500 might continue, at optional block 515, by providing access to the one or more services to the user device located at the customer premises via the local terminal. Alternatively, based on a determination that the local terminal cannot provide access to the one or more services, the method 500, at block 520, might instead continue by querying, with the local terminal, a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services.

The first remote terminal may be one or more central offices located within at least one of a neighborhood or a city, and/or the like. The one or more central offices might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application specific integrated circuits (“ASIC”), or a system on a chip (“SoC”), and/or the like. In some cases, the first remote terminal may be a main terminal, which is described in detail below.

The one or more rules might include, without limitation, at least one of information associated with the one or more services that a user or a customer premises has permission to access or information associated with one or more routes for accessing the one or more services. The information associated with the one or more routes for accessing the one or more services, might include, without limitation, at least one of one or more routes having a least amount of congestion or one or more routes having a least number of hops.

Based on a determination that the first remote terminal can provide access to the one or more services, method 500, at optional block 525, might continue by providing access to the one or more services to the user device located at the customer premises via the first remote terminal and the local terminal. Alternatively, based on a determination that the first remote terminal can provide the one or more rules for accessing the one or more services, the method 500, at block 530, might include, without limitation, receiving, with the local terminal and from the first remote terminal, the one or more rules for accessing the one or more services, and accessing, with the local terminal, the one or more services based on the one or more rules. Method 500 might continue onto the process at optional block 535 in FIG. 5B or the process at optional block 555 in FIG. 5C, following the circular marker denoted, “A.”

In some cases, based on a determination that the first remote terminal is experiencing at least one of congestion or an outage, the method 500, at optional block 535 (following circular marker denoted, “A”, from FIG. 5A), might query, with the local terminal, a second remote terminal, to determine at least one of whether the second remote terminal can provide access to the one or more services or whether the second remote terminal can provide the one or more rules for accessing the one or more services. Based on a determination that the second remote terminal can provide access to the one or more services, method 500 might continue by providing access to the one or more services to the user device located at the customer premises via the second remote terminal and the local terminal. Alternatively, based on a determination that the second remote terminal can provide the one or more rules for accessing the one or more services, the method 500, at optional block 540, might include, without limitation, receiving, with the local terminal and from the second remote terminal, the one or more rules for accessing the one or more services, and accessing, with the local terminal, the one or more services based on the one or more rules.

In various instances, based on a determination that the first remote terminal is experiencing at least one of congestion or an outage, the method 500, at optional block 545, might include querying, with the local terminal, a first main terminal, to determine at least one of whether the first main terminal can provide access to the one or more services or whether the first main terminal can provide the one or more rules for accessing the one or more services. Based on a determination that the first main terminal can provide access to the one or more services, method 500 might continue by providing access to the one or more services to the user device located at the customer premises via the first main terminal and the local terminal. Alternatively, based on a determination that the first main terminal can provide the one or more rules for accessing the one or more services, the method 500, at optional block 550, might include, without limitation, receiving, with the local terminal and from the first main terminal, the one or more rules for accessing the one or more services, and accessing, with the local terminal, the one or more services based on the one or more rules.

In some embodiments, based on a determination that the first remote terminal cannot provide access to the one or more services and cannot provide one or more rules for accessing the one or more services, the method 500 might continue, at optional block 555 (following circular marker denoted, “A”, from FIG. 5A), by querying, with the local terminal, a first main terminal, to determine at least one of whether the first main terminal can provide access to the one or more services or whether the first main terminal can provide the one or more rules for accessing the one or more services.

The main terminal might be communicatively coupled to one or more remote terminals and/or local terminals, and/or the like. The first main terminal may be a main central office located within at least one of a city, a region, a state, or a country. The main central office might include one or more computing systems. The one or more computing systems might be implemented on, without limitation, at least one of one or more desktop computer systems, one or more server computers, one or more dedicated custom hardware appliances, one or more programmable logic controllers, one or more single board computers, one or more field programmable gate arrays (“FPGA”), one or more application specific integrated circuits (“ASIC”), or a system on a chip (“SoC”), and/or the like.

The first main terminal may include a database having a master list of one or more rules for accessing one or more services for one or more customer premises within a geographic region. The first main terminal may act as the primary resource for accessing one or more services for one or more customer premises, one or more local terminals, and one or more remote terminals within the geographic region. The geographic region might include, without limitation, at least one of a city, a region, a state, or a country. The master list may include, without limitation, at least one of information and/or rules associated with one or more customers or one or more customer premises within at least one of a city, a region, a state, or a country, information and/or rules associated with the one or more services that the one or more customers or one or more customer premises have permission to access, or information and/or rules associated with one or more routes for accessing the one or more services, and/or the like.

Based on a determination that the first main terminal can provide access to the one or more services, method 500 might continue by providing access to the one or more services to the user device located at the customer premises via the first main terminal and the local terminal. Alternatively, based on a determination that the first main terminal can provide the one or more rules for accessing the one or more services, the method 500, at optional block 560, might include, without limitation, receiving, with the local terminal and from the first main terminal, the one or more rules for accessing the one or more services, and accessing, with the local terminal, the one or more services based on the one or more rules.

At optional block 565, the method 500 might further include, based on a determination that the first main terminal cannot provide access to the one or more services and cannot provide one or more rules for accessing the one or more services, querying, with the local terminal via the first main terminal, a second main terminal, to determine at least one of whether the second main terminal can provide access to the one or more services or whether the second main terminal can provide the one or more rules for accessing the one or more services. Based on a determination that the main terminal can provide access to the one or more services, method 500 might continue by providing access to the one or more services to the user device located at the customer premises via the second main terminal and the local terminal. Alternatively, based on a determination that the second main terminal can provide the one or more rules for accessing the one or more services, the method 500, at optional block 570, might include, without limitation, receiving, with the local terminal and from the second main terminal, the one or more rules for accessing the one or more services, and accessing, with the local terminal, the one or more services based on the one or more rules.

In various cases, the second main terminal might provide a backup of the one or more rules of the first main terminal. When the first main terminal is experiencing congestion or an outage, the first main terminal might automatically pass the query from the local terminal to the second main terminal without processing the query. The first main terminal and the second main terminal may be located in at least one of different cities, different regions, different states, or different countries, and the first main terminal and the second main terminal may be communicatively coupled together via low-latency transport lines.

Exemplary System and Hardware Implementation

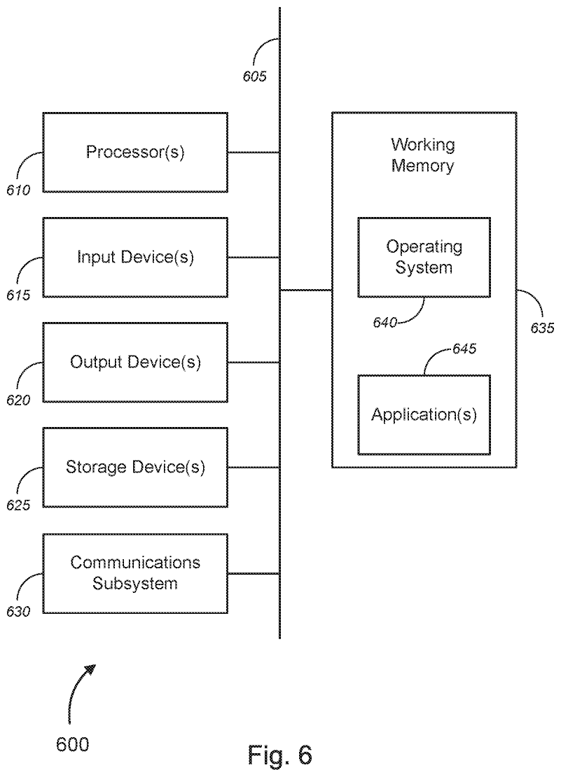

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., computing systems within local terminals 110, 210, 310, and 410, computing systems within remote terminals 115, 215, 315, and 415, and computing systems within main terminals 120, 130, 220, 230, 320, 330, 420, and 430, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., computing systems within local terminals 110, 210, 310, and 410, computing systems within remote terminals 115, 215, 315, and 415, and computing systems within main terminals 120, 130, 220, 230, 320, 330, 420, and 430, etc.), described above with respect to FIGS. 1-5—is shown comprising hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further comprise a working memory 635, which can include a RAM or ROM device, as described above.

The computer or hardware system 600 also may comprise software elements, shown as being currently located within the working memory 635, including an operating system 640, device drivers, executable libraries, and/or other code, such as one or more application programs 645, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

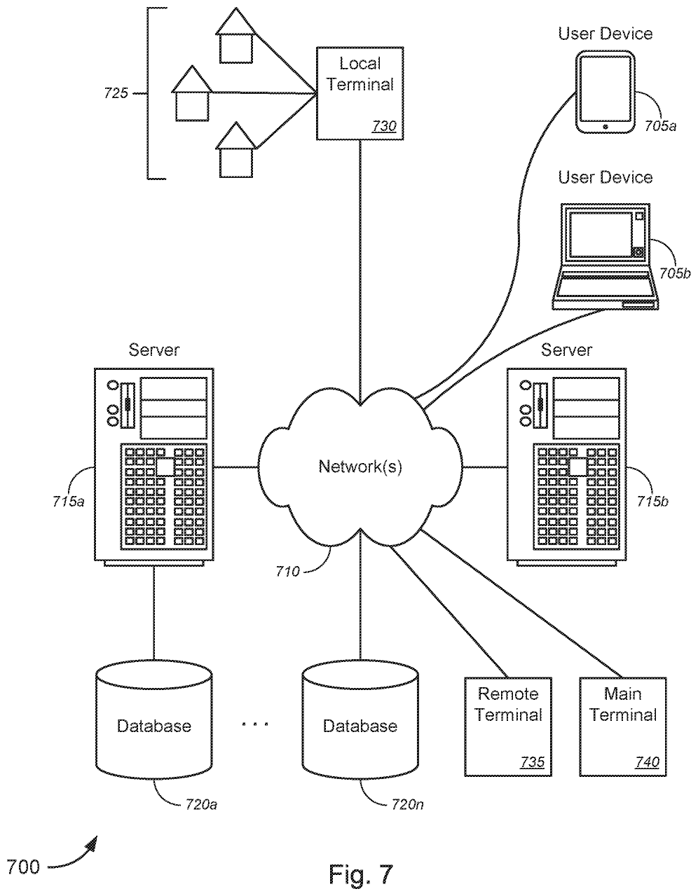

As noted above, a set of embodiments comprises methods and systems for implementing accessing of one or more services via a local terminal, and, more particularly, to methods, systems, and apparatuses for implementing accessing of one or more services via a local terminal located on an external portion of a customer premises. FIG. 7 illustrates a schematic diagram of a system 700 that can be used in accordance with one set of embodiments. The system 700 can include one or more user computers, user devices, or customer devices 705. A user computer, user device, or customer device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 705 can also have any of a variety of applications, including one or more applications configured to perform methods provided by various embodiments (as described above, for example), as well as one or more office applications, database client and/or server applications, and/or web browser applications. Alternatively, a user computer, user device, or customer device 705 can be any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user computers, user devices, or customer devices 705, any number of user computers, user devices, or customer devices can be supported.

Certain embodiments operate in a networked environment, which can include a network(s) 710. The network(s) 710 can be any type of network familiar to those skilled in the art that can support data communications using any of a variety of commercially available (and/or free or proprietary) protocols, including, without limitation, TCP/IP, SNA™, IPX™, AppleTalk™, and the like. Merely by way of example, the network(s) 710 (similar to the communication connections communicatively coupling local terminals 110, 210, 310, and 410, remote terminals 115, 215, 315, and 415, and/or main terminals 120, 130, 220, 230, 320, 330, 420, and 430, etc. of FIG. 1, 2, 3, or 4, respectively, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 705 and/or another server 715. In some embodiments, an application server can perform one or more of the processes for implementing accessing of one or more services via a local terminal, and, more particularly, to methods, systems, and apparatuses for implementing accessing of one or more services via a local terminal located on an external portion of a customer premises, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer, user device, or customer device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720a-720n (collectively, “databases 720”). The location of each of the databases 720 is discretionary: merely by way of example, a database 720a might reside on a storage medium local to (and/or resident in) a server 715a (and/or a user computer, user device, or customer device 705). Alternatively, a database 720n can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

According to some embodiments, system 700 might further comprise customer premises 725 (similar to customer premises 105, 205, 305, and 405 of FIGS. 1, 2, 3, and 4, respectively), local terminal 730 (similar to local terminals 110, 210, 310, and 410 of FIGS. 1, 2, 3, and 4, respectively), remote terminal 735 (similar to remote terminals 115, 215, 315, and 415 of FIGS. 1, 2, 3, and 4, respectively), and main terminal 740 (similar to main terminals 120, 130, 220, 230, 320, 330, 420, and 430 of FIGS. 1, 2, 3, and 4, respectively).

In operation, the local terminal 730 may receive a request for one or more services from a user device at customer premises 725. The local terminal 730 may determine whether the local terminal 730 can provide access to the one or more services requested by the user at the customer premises 725. Based on a determination that the local terminal 730 cannot provide access to the one or more services, the local terminal 730 might query a first remote terminal 735 that is located remote from the local terminal 730 to determine at least one of whether the first remote terminal 735 can provide access to the one or more services or whether the first remote terminal 735 can provide one or more rules for accessing the one or more services. Based on a determination that the first remote terminal 735 can provide the one or more rules for accessing the one or more services, the local terminal 730 may receive the one or more rules from the first remote terminal 735 and may access the one or more services based on the one or more rules.

Based on a determination that the first remote terminal 735 cannot provide access to the one or more services and cannot provide one or more rules for accessing the one or more services, the local terminal 730 might query a first main terminal 740 to determine at least one of whether the first main terminal 740 can provide access to the one or more services or whether the first main terminal 740 can provide the one or more rules for accessing the one or more services. Based on a determination that the first main terminal 740 can provide the one or more rules for accessing the one or more services, the local terminal 730 may receive, from the first main terminal 740, the one or more rules for accessing the one or more services and may access the one or more services based on the one or more rules.

These and other functions of the system 700 (and its components) are described in greater detail above with respect to FIGS. 1-5.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a local terminal located on an external portion of a customer premises, a request for one or more services;
determining, with the local terminal, whether the local terminal can provide access to the one or more services;
based on a determination that the local terminal cannot provide access to the one or more services, querying, with the local terminal, a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and
based on a determination that the first remote terminal can provide the one or more rules for accessing the one or more services, receiving, with the local terminal and from the first remote terminal, the one or more rules for accessing the one or more services, and accessing, with the local terminal, the one or more services based on the one or more rules.

2. The method of claim 1, wherein the local terminal is a distribution point unit located on the external portion of the customer premises.

3. The method of claim 1, wherein the first remote terminal is a central office located within at least one of a neighborhood or a city.

4. The method of claim 1, wherein the one or more services comprise at least one of one or more voice services, one or more audio services, one or more video services, or one or more data services.

5. The method of claim 1, wherein the one or more rules comprise at least one of information associated with the one or more services that a user or a customer premises has permission to access or information associated with one or more routes for accessing the one or more services.

6. The method of claim 5, wherein the information associated with the one or more routes for accessing the one or more services comprises at least one of one or more routes having a least amount of congestion or one or more routes having a least number of hops.

7. The method of claim 1, wherein the local terminal is communicatively coupled to the first remote terminal and a second remote terminal, and based on a determination that the first remote terminal is experiencing at least one of congestion or an outage and based on the determination that the local terminal cannot provide access to the one or more services, querying, with the local terminal, the second remote terminal communicatively coupled to the local terminal to determine at least one of whether the second remote terminal can provide access to the one or more services or whether the second remote terminal can provide one or more rules for accessing the one or more services.

8. The method of claim 1, further comprising:
based on a determination that the first remote terminal cannot provide access to the one or more services and cannot provide one or more rules for accessing the one or more services, querying, with the local terminal, a first main terminal, to determine at least one of whether the first main terminal can provide access to the one or more services or whether the first main terminal can provide the one or more rules for accessing the one or more services; and
based on a determination that the first main terminal can provide the one or more rules for accessing the one or more services, receiving, with the local terminal and from the first main terminal, the one or more rules for accessing the one or more services, and accessing, with the local terminal, the one or more services based on the one or more rules.

9. The method of claim 8, wherein the main terminal is communicatively coupled to the one or more remote terminals.

10. The method of claim 8, wherein the main terminal is a main central office located within at least one of a city, a region, a state, or a country.

11. The method of claim 8, wherein the main terminal comprises a database having a master list of the one or more rules for accessing the one or more services.

12. The method of claim 11, wherein the master list comprises at least one of information associated with one or more customers or one or more customer premises within at least one of a city, a region, a state, or a country, information associated with the one or more services that the one or more customers or the one or more customer premises have permission to access, or information associated with one or more routes for accessing the one or more services.

13. The method of claim 8, further comprising:
based on a determination that the first main terminal cannot provide access to the one or more services and cannot provide one or more rules for accessing the one or more services, querying, with the local terminal via the first main terminal, a second main terminal, to determine at least one of whether the second main terminal can provide access to the one or more services or whether the second main terminal can provide the one or more rules for accessing the one or more services, wherein the second main terminal is communicatively coupled to the first main terminal; and
based on a determination that the second main terminal can provide the one or more rules for accessing the one or more services, receiving, with the local terminal and from the second main terminal via the first main terminal, the one or more rules for accessing the one or more services, and accessing, with the local terminal, the one or more services based on the one or more rules.

14. The method of claim 13, wherein the second main terminal provides a backup of the one or more rules of the first main terminal.

15. The method of claim 13, wherein, when the first main terminal is experiencing congestion or an outage, the first main terminal automatically passes the query from the local terminal to the second main terminal without processing the query.

16. The method of claim 13, wherein the first main terminal and the second main terminal are located in at least one of different cities, different regions, different states, or different countries, and wherein the first main terminal and the second main terminal are communicatively coupled together via low-latency transport lines.

17. The method of claim 1, further comprising:
based on a determination that the first remote terminal is experiencing at least one of congestion or an outage, querying, with the local terminal, a first main terminal, to determine at least one of whether the first main terminal can provide access to the one or more services or whether the first main terminal can provide the one or more rules for accessing the one or more services; and
based on a determination that the first main terminal can provide the one or more rules for accessing the one or more services, receiving, with the local terminal and from the first main terminal, the one or more rules for accessing the one or more services, and accessing, with the local terminal, the one or more services based on the one or more rules.

18. The method of claim 17, wherein the first remote terminal automatically passes the query from the local terminal to the first main terminal without processing the query.

19. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a request for one or more services;
determine whether the apparatus can provide access to the one or more services, wherein the apparatus is located on an external portion of a customer premises;
based on a determination that the apparatus cannot provide access to the one or more services, query a first remote terminal among one or more remote terminals that are located remote from the apparatus and communicatively coupled to the apparatus to determine at least one of whether the first remote terminal can provide access to the one or more services or whether the first remote terminal can provide one or more rules for accessing the one or more services; and
based on a determination that the first remote terminal can provide the one or more rules for accessing the one or more services, receive, from the first remote terminal, the one or more rules for accessing the one or more services, and access the one or more services based on the one or more rules.

20. A system, comprising:
a local terminal, the local terminal located on an external portion of a customer premises and comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the local terminal to:
receive a request for one or more services;
determine whether the local terminal can provide access to the one or more services;
based on a determination that the local terminal cannot provide access to the one or more services, query a first remote terminal among one or more remote terminals that are located remote from the local terminal and communicatively coupled to the local terminal to determine at least one of whether the first remote terminal can provide access to the one or more services or whether the first remote terminal can provide one or more rules for accessing the one or more services; and
based on a determination that the first remote terminal can provide the one or more rules for accessing the one or more services, receive, from the first remote terminal, the one or more rules for accessing the one or more services, and access the one or more services based on the one or more rules; and
the first remote terminal, the first remote terminal comprising:
at least one second processor; and
a second non-transitory computer readable medium communicatively coupled to the at least one second processor, the second non-transitory computer readable medium having stored thereon computer software comprising a second set of instructions that, when executed by the at least one second processor, causes the first remote terminal to:
receive the query for the one or more services from the local terminal;
determine at least one of whether the first remote terminal can provide access to the one or more services or whether the first remote terminal can provide one or more rules for accessing the one or more services; and
based on a determination that the first remote terminal can provide the one or more rules for accessing the one or more services, send the one or more rules to the local terminal for accessing the one or more services.
